(19) United States
(12) Patent Application Publication
(10) Pub. No.: US 2005/0021388 A1
(43) Pub. Date: Jan. 27, 2005

(54) Survey management system and method of using the same

(76) Inventors: Christopher L. Hatcher, Albany, GA (US); Yuill Duncan Moore JR., Albany, GA (US)

Correspondence Address: MCKENNA LONG & ALDRIDGE LLP;Song K. Jung, 1900 K Street, N.W., Washington, DC, 20006, US

(21) Appl. No.: 10/857,352

(22) Filed: Jun. 1, 2004

Related U.S. Application Data
(60) Provisional application No. 60/474,237, filed on May 30, 2003.

(51) Int. Cl. G06F 17/60

(52) U.S. Cl. 705/10

(57) ABSTRACT

A system and method of enabling organizations to remotely survey clients (e.g., customers, employees, etc.) from a point of sale, point of service, etc., uses personal digital assistants (PDAs) to collect survey-based data from clients and generate real-time reports based on the collected data.

This application claims the benefit of U.S. Provisional Patent Application No. 60/474,237, filed on May 30, 2003, which is hereby incorporated by reference for all purposes as if fully set forth herein.

### BACKGROUND OF THE INVENTION

1. Field of the Invention

The present invention relates to a system and method of enabling organizations to remotely survey clients (e.g., customers, employees, etc.) from a point of sale, point of service, or the like. More particularly, the present invention relates to the use of personal digital assistants (PDAs) to collect survey-based data from clients.

2. Discussion of the Related Art

Various systems and methods have been used to collect survey data. Conventional systems and methods include answering survey application in the form of written questionnaires, telephone solicitations, and the like. Implementation of such systems, however, can be time consuming and their results can be inaccurate. Many potential responders will not fill out a questionnaire or answer questions from a caller. Further, information collected from completed questionnaires cannot be analyzed quickly. Thus, it would be beneficial to provide a survey management system and method of using the same that reduces or eliminates the aforementioned shortcomings.

### SUMMARY OF THE INVENTION

Accordingly, the present invention is directed to a survey management system and method of using the same that substantially obviates one or more of the problems due to limitations and disadvantages of the related art.

An advantage of the present invention provides a system and method for collecting survey-based data.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, a method of administering and managing surveys may, for example, include transmitting a survey application to a communications device remotely located at a client site from a survey management server; storing administration results of the loaded survey application within the remotely located communications device; and transmitting the stored results from the remotely located communications device to the survey management server.

In another aspect of the present invention, a survey management system may, for example, include a survey management server; a communications device, remotely located at a client site; connection means for connecting the survey management server to the communications device; and survey management software installed on the survey management server and on the communications device enabling data related to a survey application to be transmitted between the survey management server and the communications device.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a survey management system in accordance with the principles of the present invention.

### DETAILED DESCRIPTION OF THE ILLUSTRATED EMBODIMENTS

Reference will now be made in detail to embodiments of the present invention, examples of which are illustrated in the accompanying drawings.

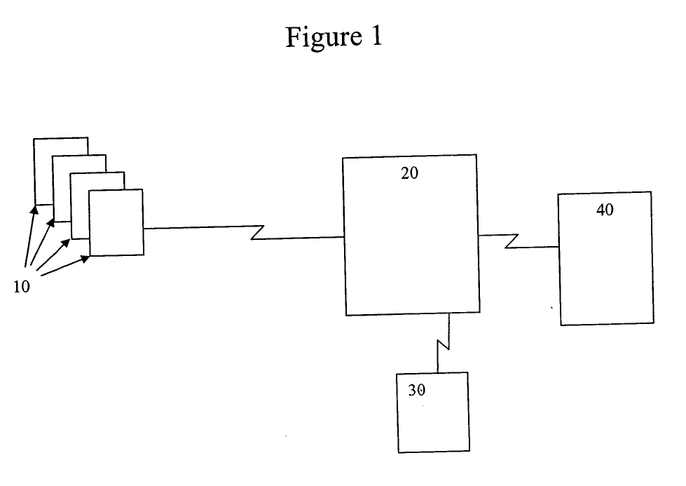

According to principles of the present invention, and as exemplarily shown in FIG. 1, at least one suitable communications device 10 such as a personal digital assistant (PDA), or the like, may be deployed to a client site (e.g., hospital, bank, restaurant, etc.) where a client (e.g., survey administrator) may be briefly trained on the use of the PDA and survey management software (described in greater detail below) that is installed thereon. Subsequently, the client may administer survey applications (e.g., questionnaires) loaded onto the PDAs at the client sites. In one aspect of the present invention, the PDAs may retain information gathered from the completed questionnaires until the client connects the PDA to a survey management server 20 and transmits the information gathered from the completed questionnaires to the survey management server 20, as will be described in greater detail below).

In one aspect of the present invention, the survey management software may enable information to be transmitted from the PDA at the client site to the survey management server 20. In another aspect of the present invention, the survey management software may, for example, run on Microsoft's NET compact framework and enable a survey management server to control the “look and feel” of survey applications loaded onto the PDAs as well as enable the survey management server 20 to determine the types of survey questions/responses (e.g., radio buttons, “select all that apply,” free text, etc.) that are to be included within the survey application. In another aspect of the present invention, the survey management software may also allow for branching logic to be built into the survey application.

According to principles of the present invention, the survey management software may, for example, include an update manager that allows the PDAs to be synchronized with a survey management database 30. In one aspect of the present invention, the survey management database 30 may be connected to the survey management sever 20 via Internet connection. A connection between the PDAs and the Internet may be established via an analog phone line using, for example, a 56 k Modem; a direct connection using a network card in, for example, a compact flash ethernet card; a WiFi connection using, for example, a wireless card and router; and the like.

After the PDA is connected to the survey management server 20, the update manager loaded on the PDA may: (1) send any existing survey results to the survey management server 20; (2) check for and retrieve any questionnaire/software updates; and (3) restart the survey application loaded on the PDA. Further, the update manager installed on the PDAs may enable clients to manage additions, deletions, and/or other changes to their survey applications from remote locations during the synchronization process.

According to the principles of the present invention, the update manager may also be installed within the survey management server. Installed on the survey management server, the update manager may: (1) manage the survey application and other business applications loaded onto the PDAs; (2) “pull-in” client information from the remotely located PDAs; (3) “push-out” new or updated survey applications to the remotely located PDAs; (4) monitor the last connection time of a PDA; (5) determine which version of a survey application or business application a particular PDA is running; (6) turn survey services on or off as required; (7) handle multiple concurrent connections to multiple PDAs; and (8) operate multiple surveys on individual PDAs.

According to principles of the present invention, the synchronization process may comprise a two-step process wherein: (1) the update manager on the survey management server pulls information from the PDA and places the pulled information into the survey management database for reporting; and (2) the update manager on the survey management server pushes any changes intended for the PDA to the remotely located PDA. In one aspect of the present invention, the pushed information may, for example, include: (1) changes to survey questions; (2) changes to survey answer choices; (3) changes to the order of the survey items; (4) addition of new applications (e.g., survey or other business application); and (5) any other executables.

After the connection is established between the PDA and the survey management server, data from the PDAs may be transmitted to the survey management database and, in turn, be used to populate an Internet-based report. In one aspect of the present invention, the Internet-based report may, for example, be populated automatically on a periodic basis (e.g., every 60 minutes), or the like. In one aspect of the present invention, the reports may be transmitted to a web server that may be accessed through a properly credentialed representative of the client. Accordingly, the principles of the present invention may be used to present information related to the survey applications to the client in real time.

Thus, as described above, the present invention provides a system and method of enabling organizations to remotely survey clients such as customers, employees, etc., from a point of sale/service. According to principles of the present invention, answers to survey applications loaded onto personal digital assistants (PDAs) may be transmitted from client sites which are remotely located from a survey management server. The transmitted information may then be used to generate reports, accessible from the Internet, in real-time.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method of administering and managing surveys, comprising:
transmitting a survey application to a communications device of a client remotely located at a client site from a survey management server;
storing results of the loaded survey application within the remotely located communications device; and
transmitting the stored results from the remotely located communications device to the survey management server.

2. The method of claim 1, wherein the communications device includes a personal digital assistant.

3. The method of claim 1, further comprising generating a report based on the transmitted results.

4. The method of claim 3, further comprising publishing the generated report to the world wide web.

5. The method of claim 1, further including, prior to transmitting the stored results:
establishing a connection between the communications device and the survey management server; and
synchronizing the communications device with a survey management database connected to the survey management server.

6. The method of claim S, wherein the establishing uses one of a modem, a network card, or a wireless network card.

7. The method of claim 5, wherein the synchronizing includes:
transmitting data from the communications device into the survey management database; and
transmitting data from the survey management server to the client.

8. The method of claim 7, wherein the transmitting data from the communications device includes transmitting at least one of existing results of administered surveys.

9. The method of claim 7, wherein the transmitting data from the survey management server includes transmitting at least one of changes to survey questions, changes to survey answer choices, changes in order of survey items, survey applications, and business applications.

10. The method of claim 5, wherein the synchronizing includes managing at least one of an addition, deletion, and alteration to the transmitted survey application.

11. The method of claim 1, further including deploying the remotely located communications device to the client site.

12. A survey management system, comprising:
a survey management server;
a communications device, remotely located at a client site;
connection means for connecting the survey management server to the communications device; and
survey management software installed on the survey management server and on the communications device enabling data related to a survey application to be transmitted between the survey management server and the communications device.

13. The survey management system of claim 12, wherein the connection means includes one of a modem, a network card, or a wireless network card.

14. The survey management system of claim 12, further comprising a survey management database connected to the survey management server for storing data transmitted from the communications device.

15. The survey management system of claim 14, wherein the survey management software includes an update manager for controlling a synchronization process that enables the data related to the survey application to be transmitted between the survey management server and the communications device.

16. A method of administering and managing surveys, comprising:
connecting a communications device to a survey management server;
transmitting a survey application to a communications device from a survey management server;
storing the survey application on the communications device;
storing results of a completed survey application on the communications device;
connecting the communications device having the results stored thereon to the survey management server; and
transmitting the stored results from the communications device to the survey management server.

17. The method of claim 16, further comprising generating a report based on the transmitted results.

18. The method of claim 17, further comprising publishing the generated report to the world wide web.

19. The method of claim 16, further including, prior to transmitting the stored results, synchronizing the communications device with a survey management database connected to the survey management server.

20. The method of claim 16, further comprising transmitting at least one of changes to survey questions, changes to survey answer choices, changes in order of survey items, survey applications, and business applications.
